(19) United States
(12) Patent Application Publication
(10) Pub. No.: US 2022/0226888 A1
(43) Pub. Date: Jul. 21, 2022

(54) METHOD AND SYSTEM FOR OPERATING A METAL DROP EJECTING THREE-DIMENSIONAL (3D) OBJECT PRINTER TO SHORTEN OBJECT FORMATION TIME

(71) Applicant: Xerox Corporation, Norwalk, CT (US)

(72) Inventors: James L. Giacobbi, Penfield, NY (US); Donald R. Fess, Rochester, NY (US); Matthew R. McLaughlin, Rochester, NY (US); Victoria L. Warner, Caledonia, NY (US)

(21) Appl. No.: 17/154,063

(22) Filed: Jan. 21, 2021

(51) Int. Cl. B22D 23/00; B33Y 10/00; B33Y 30/00

(52) U.S. Cl. CPC B22D 23/003; B33Y 30/00; B33Y 10/00

(57) ABSTRACT

A three-dimensional (3D) metal object manufacturing apparatus operates an ejector in an ejection mode to form exterior portions of an object and in an extrusion mode to form interior portions within a perimeter of an object layer. In the extrusion mode, the ejector continuously extrudes melted metal to fill the interior portions quickly.

### TECHNICAL FIELD

This disclosure is directed to melted metal ejectors used in three-dimensional (3D) object printers and, more particularly, to operation of the ejectors to form three-dimensional (3D) metal objects.

### BACKGROUND

Three-dimensional printing, also known as additive manufacturing, is a process of making a three-dimensional solid object from a digital model of virtually any shape. Many three-dimensional printing technologies use an additive process in which an additive manufacturing device forms successive layers of the part on top of previously deposited layers. Some of these technologies use ejectors that eject UV-curable materials, such as photopolymers or elastomers. The printer typically operates one or more extruders to form successive layers of the plastic material that form a three-dimensional printed object with a variety of shapes and structures. After each layer of the three-dimensional printed object is formed, the plastic material is UV cured and hardens to bond the layer to an underlying layer of the three-dimensional printed object. This additive manufacturing method is distinguishable from traditional object-forming techniques, which mostly rely on the removal of material from a work piece by a subtractive process, such as cutting or drilling.

Recently, some 3D object printers have been developed that eject drops of melted metal from one or more ejectors to form 3D objects. These printers have a source of solid metal, such as a roll of wire or pellets, that are fed into a heating chamber where they are melted and the melted metal flows into a chamber of the ejector. The chamber is made of non-conductive material around which an uninsulated electrical wire is wrapped. An electrical current is passed through the conductor to produce an electromagnetic field to cause the meniscus of the melted metal at a nozzle of the chamber to separate from the melted metal within the chamber and be propelled from the nozzle. A platform opposite the nozzle of the ejector is moved in a X-Y plane parallel to the plane of the platform by a controller operating actuators so the ejected metal drops form metal layers of an object on the platform and another actuator is operated by the controller to alter the position of the ejector or platform in the vertical or Z direction to maintain a constant distance between the ejector and an uppermost layer of the metal object being formed. This type of metal drop ejecting printer is also known as a magnetohydrodynamic printer.

Most metal drop ejecting printers have a single ejector that operates at an ejection frequency in a range of about 50 Hz to about 1 KHz and that eject drops having a diameter of about 50 μm. This firing frequency range and drop size extends the time required to form metal objects over the times needed to form objects made with plastic or other known materials. Although some metal drop ejecting printers have one or more printheads or more than one nozzle fluidly coupled to a common manifold, they still are limited to these ejection frequencies and drop sizes. Three-dimensional object printers having multiple nozzles that form plastic objects and the like are known to use a single nozzle for formation of fine features or the perimeters of layers and then increase the number of nozzles used to infill the layer. By increasing the number of nozzles used, a greater amount of the thermoplastic material can be dispensed into the interior regions of a layer in a short amount of time to improve the production time for the objects manufactured by such printers. Maintaining an adequate supply of melted metal to multiple printheads or nozzles is difficult, especially if the number of nozzles being used is selectively varied during the object formation. Being able to operate a metal drop ejecting printer to provide higher effective melted metal dispensing rates and form larger swaths or ribbons of melted metal to decrease the time for object formation would be beneficial.

### SUMMARY

A new method of operating a metal drop ejecting apparatus to provide higher effective melted metal dispensing rates and form larger swaths or ribbons of melted metal to decrease the time for object formation. The method includes identifying a portion of a layer in an object to be formed on a platform as exterior or interior using a layer model of the object, operating an ejector in an ejection mode when the portion of the object to be formed is identified as being exterior, and operating the ejector in an extrusion mode when the portion of the object to be formed is identified as being interior.

A new metal drop ejecting apparatus provides higher effective melted metal dispensing rates and forms larger swaths or ribbons of melted metal to decrease the time for object formation forms. The apparatus includes a melter configured to receive and melt a solid metal, an ejector operatively connected to the melter to receive melted metal from the melter, a platform configured to support a substrate, the platform being positioned opposite the ejector, a user interface configured to receive a digital data model of an object to be formed on the platform, and a controller operatively connected to the melter, the ejector, and the user interface. The controller is configured to generate a layer model of the object to be formed on the platform using the digital data model, identify a portion of the object to be formed on the platform as exterior or interior using the layer model of the object, operating the ejector in an ejection mode when the portion of the object to be formed is identified as being exterior, and operating the ejector in an extrusion mode when the portion of the object to be formed is identified as being interior.

### BRIEF DESCRIPTION OF THE DRAWINGS

The foregoing aspects and other features of a metal ejecting 3D object printer and its operation that provides higher effective melted metal dispensing rates and forms larger swaths or ribbons of melted metal to decrease the time for object formation are explained in the following description, taken in connection with the accompanying drawings.

FIG. 1 depicts an additive manufacturing system that operates a liquid metal drop ejector to provide higher effective melted metal dispensing rates and form larger swaths or ribbons of melted metal to decrease the time for object formation.

FIG. 2A and FIG. 2B depict formation of a layer of a metal object using the system of FIG. 1.

FIG. 3 illustrates how an ejector in the system of FIG. 1 is supplemented with additional melted metal that is adequate to support the formation of larger swaths or ribbons.

FIG. 4 illustrates the parameters for the equation used to regulate the amount of melted metal in the ejector of FIG. 3.

FIG. 5 is a flow diagram of a process that operates the printing system of FIG. 1 to infill interior regions of layers in metal objects more quickly.

### DETAILED DESCRIPTION

For a general understanding of the environment for the system and its operation as disclosed herein as well as the details for the device and its operation, reference is made to the drawings. In the drawings, like reference numerals designate like elements.

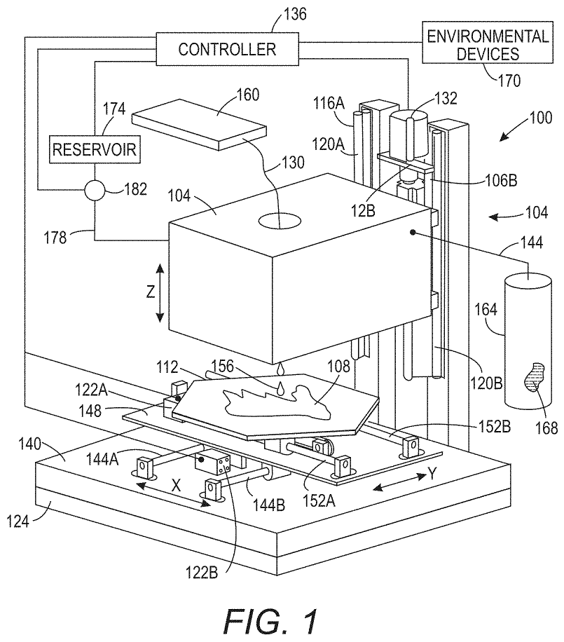

FIG. 1 illustrates an embodiment of a melted metal 3D object printer 100 that has a printhead 104 that operates in two modes, an ejection mode for formation of exterior surfaces and features and an extrusion mode for the infill of interiors. As used in this document, “ejection mode” means operation of a printhead to eject discrete drops of melted metal from a nozzle of the printhead and “extrusion mode” means operation of the printhead to exude a continuous stream of melted metal from the same nozzle of the printhead. A source of bulk metal 160, such as metal wire 130, is fed into the printhead and melted to provide melted metal for a chamber within the printhead. As used in this document, the term “bulk metal” means conductive metal available in aggregate form, such as wire of a commonly available gauge or pellets of macro-sized proportions. An inert gas supply 164 provides a pressure regulated source of an inert gas 168, such as argon, to the melted metal in the printhead 104 through a gas supply tube 144 to prevent the formation of metal oxide in the printhead.

The printhead 104 is movably mounted within z-axis tracks 116A and 116B in a pair of vertically oriented members 120A and 120B, respectively. Members 120A and 120B are connected at one end to one side of a frame 124 and at another end they are connected to one another by a horizontal member 128. An actuator 132 is mounted to the horizontal member 128 and operatively connected to the printhead 104 to move the printhead along the z-axis tracks 116A and 166B. The actuator 132 is operated by a controller 136 to maintain a predetermined distance between one or more nozzles (not shown in FIG. 1) of the printhead 104 and an uppermost surface of the substrate 108 on the platform 112 and the traces being formed on the substrate 108.

Mounted to the frame 124 is a planar member 140, which can be formed of granite or other sturdy material to provide reliably solid support for movement of the platform 112. Platform 112 is affixed to X-axis tracks 144A and 144B so the platform 112 can move bidirectionally along an X-axis as shown in the figure. The X-axis tracks 144A and 144B are affixed to a stage 148 and stage 148 is affixed to Y-axis tracks 152A and 152B so the stage 148 can move bidirectionally along a Y-axis as shown in the figure. Actuator 122A is operatively connected to the platform 112 and actuator 122B is operatively connected to the stage 148. Controller 136 operates the actuators 122A and 122B to move the platform along the X-axis and to move the stage 148 along the Y-axis to move the platform in an X-Y plane that is opposite the printhead 104. Performing this X-Y planar movement of platform 112 as molten metal 156 is either ejected or extruded toward the platform 112 forms a line of melted metal drops on the substrate 108. Controller 136 also operates actuator 132 to adjust the vertical distance between the printhead 104 and the most recently formed layer on the substrate to facilitate formation of other structures on the substrate. While the molten metal 3D object printer 100 is depicted in FIG. 1 as being operated in a vertical orientation, other alternative orientations can be employed. Also, while the embodiment shown in FIG. 1 has a platform that moves in an X-Y plane and the printhead moves along the Z axis, other arrangements are possible. For example, the printhead 104 can be configured for movement in the X-Y plane and along the Z axis. Additionally, while the depicted printhead 104 has only one nozzle, it is configured in other embodiments with multiple nozzles and a corresponding array of electromagnetic actuators associated with the nozzles in a one-to-one correspondence to provide independent and selective control of the ejections from each of the nozzles and the nozzles can be supplied from different sources of bulk metal and the bulk metals of these metals can be different metals.

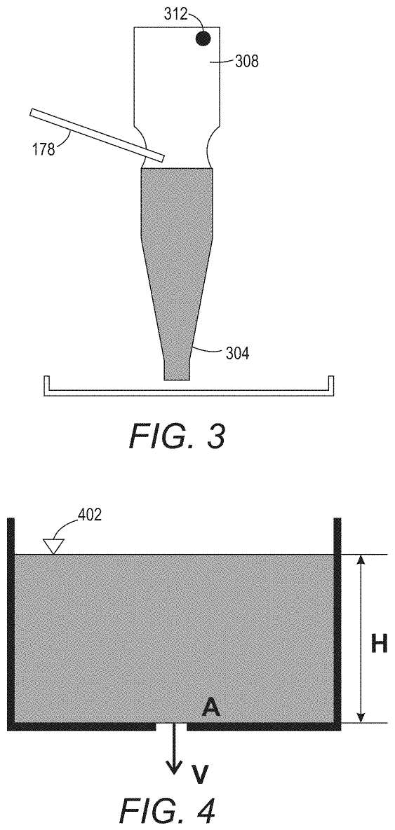

The system 100 is also provided with a reservoir of melted bulk metal 174 that is connected to the melted metal chamber within the printhead 104 by a conduit 178 having a valve 182. The controller 136 is operatively connected to the electromagnetic actuator within the printhead 104 and to the valve 182. When the controller 136 operates the printhead 104 in ejection mode, it generates control signals to operate the electromagnetic actuator to eject drops of melted metal and to keep the valve 182 closed. When the controller 136 operates the printhead 104 in extrusion mode, the controller generates control signals to open the valve 182 while monitoring the signal generated by a pressure sensor 312 (FIG. 3) within the printhead 104 to keep the printhead supplied with an amount of melted metal adequate to extrude melted metal through the nozzle continuously to support the extrusion operation of the printhead.

The controller 136 can be implemented with one or more general or specialized programmable processors that execute programmed instructions. The instructions and data required to perform the programmed functions can be stored in memory associated with the processors or controllers. The processors, their memories, and interface circuitry configure the controllers to perform the operations previously described as well as those described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits. During electronic device formation, image data for a structure to be produced are sent to the processor or processors for controller 136 from either a scanning system or an online or work station connection for processing and generation of the control signals used to operate the printhead 104.

The controller 136 of the melted metal 3D object printer 100 requires data from external sources to control the printer for 3D metal object manufacture. In general, a three-dimensional model or other digital data model of the device to be formed is stored in a memory operatively connected to the controller 136, the controller can access through a server or the like a remote database in which the digital data model is stored, or a computer-readable medium in which the digital data model is stored can be selectively coupled to the controller 136 for access. A known program, sometimes called a slicer, forms from the digital data model a layer model of the object to be manufactured. The layer model identifies the exterior portions of the layers of the object and the interior regions of the layers. The layer model is used by the controller to generate machine-ready instructions for execution by the controller 136 in a known manner to operate the components of the printer 100 and form the metal object corresponding to the layer model. The generation of the machine-ready instructions can include the production of intermediate models, such as when a CAD model of the object is converted into an STL data model, or other polygonal mesh or other intermediate representation, which can in turn be processed to generate machine instructions, such as g-code for fabrication of the device by the printer. As used in this document, the term “machine-ready instructions” means computer language commands that are executed by a computer, microprocessor, or controller to operate components of a 3D metal object additive manufacturing system to form metal objects. The controller 136 executes the machine-ready instructions to control the operations of the printhead 104, the positioning of stage 148, and the platform 112, as well as the distance between the printhead 102 and the uppermost layer of the object on the platform 112.

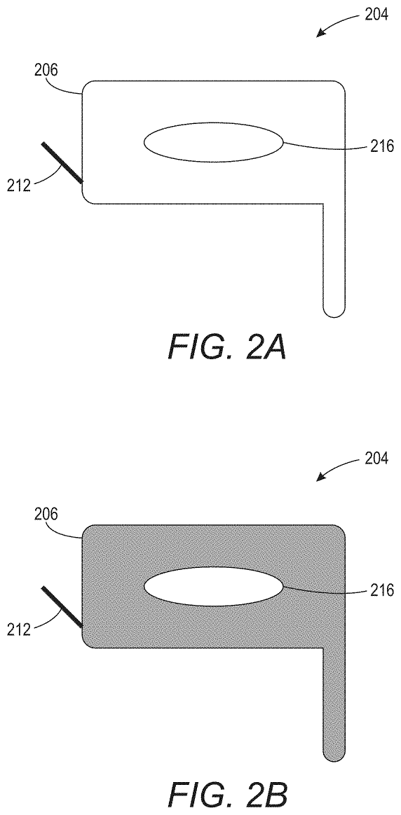

The formation of a layer 204 is shown in FIG. 2A and FIG. 2B. If the layer 204 is identified as an exterior surface of the object to be manufactured, such as the bottom layer of the object, then the controller 136 operates the printhead 104 in ejection mode to form the entire bottom surface layer. For a subsequent layer 204 that is not an exterior layer, the perimeter 208 of the layer, the feature 212, and the perimeter 208 of the opening 216 are formed while operating the printhead 104 in ejection mode since the perimeter 208 is part of the exterior of the object, the feature 212 is a solid member, and the perimeter is also on an exposed surface of the object. The controller 136 then operates the printhead 104 in extrusion mode to fill in the interior between the perimeter 208 of the layer and the perimeter 216 of the opening as shown in FIG. 2B. The operation of the printhead in extrusion mode is now described more fully. As used in this document, the term “exterior” means a surface that contacts ambient air when manufacture of the object is finished and the term “interior” means a portion of the object that does not contact ambient air when the manufacture of the object is finished.

The nozzle 304 and feed chamber 308 of the ejector in the printhead 104 are shown in FIG. 3. The electrical wire that is wrapped about the ejector to form the electromagnetic field that ejects a drop of melted ink is not shown to facilitate the discussion of the extrusion mode of the printhead. The conduit 178 to the reservoir 174 noted above directs melted metal from the reservoir 174 into the feed chamber 308 when the valve 182 is open. A pressure sensor 312 is positioned within the feed chamber 308 and it generates a signal that is transmitted to the controller 136 that indicates the pressure above the upper surface of the melted metal 316 in the feed chamber. This pressure can be regulated by operating the inert gas source 164 to increase or decrease the flow of inert gas from the gas source into the feed chamber 308. When the pressure is increased to a predetermined minimum value, the melted metal is extruded continuously from the nozzle 304. Because the melted metal is being extruded continuously, rather than in discrete drops, the supply of melted metal is diminished more rapidly. To compensate for this loss of melted metal, the controller 136 opens the valve 182 and melted metal from the reservoir 174 is urged by gravity through the conduit 178 into the feed chamber 308. Thus, continuous ribbons or swaths of melted metal are extruded from the nozzle 304 while operating the actuators that produce relative movement between the printhead 104 and the platform 112 to fill an interior area of a layer. This operation fills the layer more quickly than is possible by operating the printhead in ejection mode. Once the interior area of the layer is filled, the controller 136 closes the valve 182 and operates the inert gas source 164 to decrease the amount of gas supplied to the feed chamber 308. The controller continues this operation of the inert gas source 164 while monitoring the signal from the pressure sensor 312 until the pressure within the feed chamber 308 returns to a lower pressure that does not force the melted metal from the feed chamber 308 and through the nozzle 304. Melted metal now remains in the feed chamber 308 until an electromagnetic pulse is generated for ejecting a drop through the nozzle 304.

FIG. 4 is a depiction of the melted metal in the feed chamber 308 and its egress through the nozzle 304. To regulate the amount of melted metal in the feed chamber, the net flow out of the feed chamber is a function of the height H of the melted metal in the chamber and the volumetric flow of melted metal into the chamber. The volumetric flow out of the nozzle 304 is V=C_{d} A (2 gH)^{1/2}, where the flow volume is measured in m³/sec, A is the area of the aperture in m² and C_{d} is the discharge coefficient defined by C_{c}Cᵥ where C_{c} is the contraction coefficient, which is 0.62 for a sharp edge aperture and 0.97 for a well-rounded aperture, and Cᵥ is a velocity coefficient, which is 0.97 in some embodiments. As used in this document, the term “sharp edge aperture” means an opening in the nozzle of the ejector that is formed with straight lines and “well-rounded aperture” means an opening in the nozzle that is formed with one or more curved lines. Using a level sensor 402 that follows the upper surface of the melted metal in the chamber 308 and generates a signal indicative of the change in the level of the melted metal along with the equations noted above, the controller is configured to determine the volumetric flow out of the feed chamber 308 and operate the valve 182 to replace the displaced volume and maintain the height H of the melted metal in the feed chamber at a constant height during the extrusion mode of printhead operation.

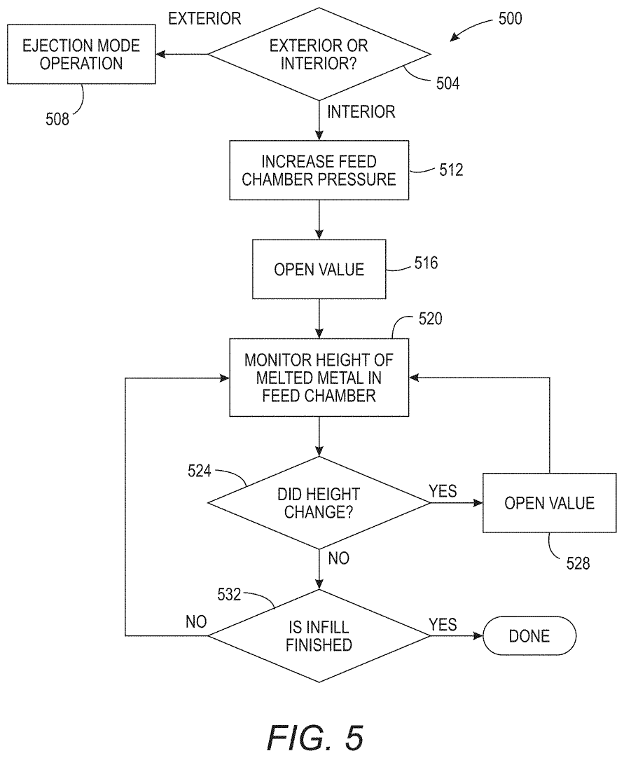

A process for operating the printer shown in FIG. 1 is shown in FIG. 5. In the description of the process, statements that the process is performing some task or function refers to a controller or general purpose processor executing programmed instructions stored in non-transitory computer readable storage media operatively connected to the controller or processor to manipulate data or to operate one or more components in the printer to perform the task or function. The controller 136 noted above can be such a controller or processor. Alternatively, the controller can be implemented with more than one processor and associated circuitry and components, each of which is configured to form one or more tasks or functions described herein. Additionally, the steps of the method may be performed in any feasible chronological order, regardless of the order shown in the figures or the order in which the processing is described.

FIG. 5 is a flow diagram 500 of a process that operates the printing system 100 to infill interior regions of layers in metal objects more quickly. The process begins by identifying whether a path for formation of a portion of a layer in the object is on an exterior surface of the object or within an interior portion (block 504). For exterior surface formation, the printhead is operated in an ejection mode in a known manner to form the layer portion (block 508). If the portion to be formed is an interior portion, then pressure within the feed chamber is monitored while the inert gas supply is operated to increase the pressure to a level that extrudes melted metal from the nozzle (block 512). The valve that enables additional melted metal to flow into the feed chamber is opened (block 516) and the height of the melted metal in the feed chamber is monitored (block 520). If the height changes (block 524), then the valve is operated to open and the resulting flow of melted metal into the chamber returns the melted metal height to the constant level (block 528). This operation continues until the interior region is filled (block 532).

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A metal drop ejecting apparatus comprising:
a melter configured to receive and melt a solid metal;
an ejector operatively connected to the melter to receive melted metal from the melter;
a platform configured to support a substrate, the platform being positioned opposite the ejector;
a user interface configured to receive a digital data model of an object to be formed on the platform; and
a controller operatively connected to the melter, the ejector, and the user interface, the controller being configured to:
generate a layer model of the object to be formed on the platform using the digital data model;
identify a portion of the object to be formed on the platform as exterior or interior using the layer model of the object;
operating the ejector in an ejection mode when the portion of the object to be formed is identified as being exterior; and
operating the ejector in an extrusion mode when the portion of the object to be formed is identified as being interior.

2. The apparatus of claim 1 further comprising:
an inert gas supply fluidly coupled to the ejector; and
the controller is operatively connected to the inert gas supply, the controller being further configured to:
operate the inert gas supply to increase a pressure within the ejector to a level sufficient to extrude melted metal from the ejector when the controller operates the ejector in the extrusion mode.

3. The apparatus of claim 2 further comprising:
a pressure sensor positioned within the ejector, the pressure sensor being configured to generate a signal indicative of a pressure within the ejector; and
the controller being operatively connected to the pressure sensor to receive the signal generated by the pressure sensor, the controller being further configured to:
adjust operation of the inert gas supply using the signal received from the pressure sensor.

4. The apparatus of claim 3 further comprising:
a level sensor configured to generate a signal indicative of a level of melted metal within the ejector; and
the controller being operatively connected to the level sensor to receive the signal generated by the level sensor, the controller being further configured to:
change an amount of melted metal supplied to the ejector using the signal generated by the level sensor.

5. The apparatus of claim 4 further comprising:
a reservoir configured to hold a volume of melted metal, the reservoir being fluidly connected to the ejector by a conduit;
a valve positioned in the conduit between the reservoir and the ejector, the valve being configured to open and close a flow path through the conduit from the reservoir to the ejector; and
the controller being operatively connected to the valve, the controller being further configured to:
operate the valve using the signal generated by the level sensor to supply melted metal selectively through the conduit from the reservoir to the ejector.

6. The apparatus of claim 5 wherein the reservoir is positioned at a higher gravitational potential than the ejector so gravity urges melted metal from the reservoir through the conduit to the ejector when the valve is opened.

7. The apparatus of claim 6, the controller being further configured to operate the valve to close the conduit to return the ejector to the ejection mode.

8. The apparatus of claim 6, the controller being further configured to:
identify a volume to be supplied from the reservoir through the conduit to the ejector using an equation V=C_{d} A (2 gH)^{1/2}, where V is the volume measured in m³/sec, A is an area of an aperture of the ejector from which the melted metal is extruded measured in m², and C_{d} is a discharge coefficient defined by C_{c}Cᵥ where C_{c} is a contraction coefficient and Cᵥ is a velocity coefficient.

9. The apparatus of claim 8 wherein the contraction coefficient is 0.62 for a sharp edge aperture of the ejector and is 0.97 for a well-rounded aperture.

10. The apparatus of claim 8 wherein the velocity coefficient is 0.97.

11. A method of operating a metal drop ejecting apparatus comprising:
identifying a portion of a layer in an object to be formed on a platform as exterior or interior using a layer model of the object;
operating an ejector in an ejection mode when the portion of the object to be formed is identified as being exterior; and
operating the ejector in an extrusion mode when the portion of the object to be formed is identified as being interior.

12. The method of claim 11 further comprising:
operating an inert gas supply to increase a pressure within the ejector to a level sufficient to extrude melted metal from the ejector when the ejector is in the extrusion mode.

13. The method of claim 12 further comprising:
adjusting operation of the inert gas supply using a signal received from a pressure sensor that indicates a pressure within the ejector.

14. The method of claim 13 further comprising:
changing an amount of melted metal supplied to the ejector using a signal received from a level sensor that indicates a level of melted metal within the ejector.

15. The method of claim 14 further comprising:
operating a valve positioned in a conduit that fluidly connects a reservoir of melted metal to the ejector to open and close using the signal generated by the level sensor to supply melted metal selectively through the conduit from the reservoir to the ejector.

16. The method of claim 15 further comprising:
using gravity to urge melted metal from the reservoir through the conduit to the ejector when the valve is open.

17. The method of claim 16 further comprising:
operating the valve to close the conduit to return the ejector to the ejection mode.

18. The method of claim 6 further comprising:
identifying a volume to be supplied from the reservoir through the conduit to the ejector using an equation V=C_{d} A (2 gH)^{1/2}, where V is the volume measured in m³/sec, A is an area of an aperture of the ejector from which the melted metal is extruded measured in m², and C_{d} is a discharge coefficient defined by C_{c}Cᵥ where C_{c} is a contraction coefficient and Cᵥ is a velocity coefficient.

19. The method of claim 18 wherein the contraction coefficient is 0.62 for a sharp edge aperture of the ejector and is 0.97 for a well-rounded aperture.

20. The method of claim 18 wherein the velocity coefficient is 0.97.
